(19) United States
(12) Patent Application Publication
(10) Pub. No.: US 2026/0255235 A1
(43) Pub. Date: Aug. 27, 2026

(54) HANDOVER METHOD, MOBILE HANDOVER APPARATUS AND WIRELESS COMMUNICATION SYSTEM

(71) Applicant: Samsung Electronics Co., Ltd., Suwon-si (KR)

(72) Inventor: Jie DENG, Suzhou (CN)

(73) Assignee: Samsung Electronics Co., Ltd., Suwon-si (KR)

(21) Appl. No.: 19/088,070

(22) Filed: Mar. 24, 2025

(30) Foreign Application Priority Data
Feb. 24, 2025 (CN) 202510203621.8

(51) Int. Cl. H04W 36/00; H04B 17/318; H04L 27/26; H04W 64/00

(52) U.S. Cl. CPC H04W 36/00837; H04B 17/328; H04L 27/261; H04W 64/003

(57) ABSTRACT

A handover method, a mobile handover apparatus and a wireless communication system are disclosed. The handover method includes obtaining first position information of a user equipment, determining whether the user equipment is in a handover area of a first cell of the base station based on the first position information, transmitting a reference signal measurement request to the user equipment in response to determining the user equipment is in the handover area, receiving reference signal strength information from the user equipment, the reference signal strength information corresponding to the reference signal measurement request, and handing over the user equipment from the first cell to a target cell adjacent to the first cell.

### CROSS REFERENCES TO RELATED APPLICATION

This application based on and claims priority under 35 U.S.C. § 119 to Chinese Patent Application No. 202510203621.8, filed on Feb. 24, 2025, the disclosure of which is incorporated by reference herein in its entirety.

### FIELD

The present disclosure relates to the field of wireless communication, and more particularly, to a handover method performed by a base station, a mobile handover apparatus and a wireless communication system.

### BACKGROUND

Mobility management on the user equipment (UE), or user terminal, by the base station in the cell depends on configuring measurement control of the user equipment. The base station transmits a downlink reference signal measurement request to the user equipment, and the user equipment periodically measures the reference signals of the current cell and adjacent cells in response to the reference signal measurement request.

Because the base station cannot predict when the user equipment will arrive at the edge of the cell covered by the base station, the user equipment continuously performs reference signal measurement, and transmits the measured reference signal to the base station when a predetermined (or alternatively, given) condition is satisfied. Such frequent measurements of user equipment result in increased power consumption.

### SUMMARY

This summary is provided to introduce a selection of concepts in a simplified form that are further described below in the Detailed Description. This summary is not intended to identify key features and/or essential features of the claimed subject matter, nor is it intended to be used as an aid in determining the scope of the claimed subject matter.

The disclosure discloses a handover method performed by a base station, and mobile handover apparatus. The base station or the mobile handover apparatus may at least generate a cell handover area model based on the trajectory data of the user equipment, and manage the mobility of the user equipment based on the cell handover area model, thereby significantly reducing the power consumption of the user equipment due to frequent measurement and reducing the probability of transaction interruption caused by handover of the user equipment.

According to example embodiments, there is provided a handover method performed by a base station including obtaining first position information of a user equipment, determining whether the user equipment is in a handover area of a first cell of the base station based on the first position information, transmitting a reference signal measurement request to the user equipment in response to determining the user equipment is in the handover area, receiving reference signal strength information from the user equipment, the reference signal strength information corresponding to the reference signal measurement request, and handing over the user equipment from the first cell to a target cell adjacent to the first cell.

According to example embodiments, there is provided a mobile handover apparatus in a wireless communication network that includes a memory configured to store information about a handover area of a current cell, and processing circuitry configured to obtain position information of a user equipment, determine whether the user equipment is in the handover area based on the position information, transmit a reference signal measurement request to the user equipment in response to determining the user equipment is in the handover area, receive reference signal strength information from the user equipment, the reference signal strength information corresponding to the reference signal measurement request, and hand over the user equipment from the current cell to a target cell adjacent to the current cell.

According to example embodiments, there is provided a wireless communication system including a user equipment, and a base station configured to obtain position information of a user equipment, determine whether the user equipment is in a handover area of a first cell of the base station based on the position information, transmit a reference signal measurement request to the user equipment in response to determining the user equipment is in the handover area, receive reference signal strength information from the user equipment, the reference signal strength information corresponding to the reference signal measurement request, and hand over the user equipment from the first cell to a target cell adjacent to the first cell, wherein the user equipment is configured to periodically perform a downlink reference signal strength measurement in response to receiving the reference signal measurement request from the base station to obtain a measured downlink reference signal strength, and transmit the reference signal strength information to the base station based on the measured downlink reference signal strength meeting a condition.

According to example embodiments, a non-transitory computer-readable storage medium stores computer instructions, wherein the computer instructions, when executed by a processor, implement the above handover method.

Other aspects and/or advantages of the inventive concepts will be partially described in the following description, and part will be clear through the description and/or may be learn through the practice of example embodiments.

### BRIEF DESCRIPTION OF THE DRAWINGS

The above and other objects, features and advantages of the present disclosure will become clearer through the following detailed description together with the accompanying drawings.

FIG. 1 is a diagram illustrating a wireless communication system.

FIG. 2 illustrates a typical handover process based on downlink reference signal measurement.

FIG. 3 is a flowchart illustrating a handover method performed by a base station according to example embodiments of the present disclosure.

FIG. 4 is flowchart illustrating a method of determining a handover area of a cell according to example embodiments of the present disclosure.

FIG. 5 is a diagram illustrating determining a handover area of the cell according to example embodiments of the present disclosure.

FIG. 6 is diagram illustrating determining a handover area of the cell according to example embodiments of the present disclosure.

FIG. 7 is a block diagram illustrating a mobile handover apparatus according to example embodiments of the present disclosure.

FIG. 8 is a block diagram illustrating a user equipment according to example embodiments of the present disclosure.

### DETAILED DESCRIPTION OF EXAMPLE EMBODIMENTS

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order (e.g., with the exception of operations explicitly identified as being required to occur in a certain order). Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The following structural or functional descriptions of examples disclosed herein are merely intended for the purpose of describing the examples and the examples may be implemented in various forms. The examples are not meant to be limited, but it is intended that various modifications, equivalents, and alternatives are also covered within the scope of the claims.

Although terms of “first” or “second” are used to explain various components, the components are not limited to the terms. These terms should be used only to distinguish one component from another component. For example, a “first” component may be referred to as a “second” component, or similarly, and the “second” component may be referred to as the “first” component according to the concept of the present disclosure.

It will be understood that when a component is referred to as being “connected to” another component, the component may be directly connected or coupled to the other component or intervening components may be present.

As used herein, the singular forms “a”, “an”, and “the” are intended to include the plural forms as well, unless the context clearly indicates otherwise. It should be further understood that the terms “comprises” and/or “comprising,” when used in this specification, specify the presence of stated features, integers, operations, elements, components or a combination thereof, but do not preclude the presence or addition of one or more other features, integers, operations, elements, components, and/or groups thereof.

Unless otherwise defined, all terms including technical or scientific terms used herein have the same meaning as (or a similar meaning to) that commonly understood by one of normal skill in the art to which examples belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

Hereinafter, examples will be described in detail with reference to the accompanying drawings. Regarding the reference numerals allocated to the elements in the drawings, it should be noted that the same elements (or similar elements) will be designated by the same reference numerals (or similar reference numerals), and redundant descriptions thereof will be omitted.

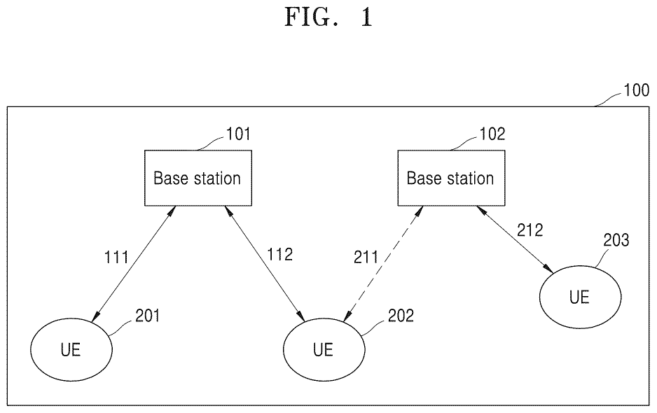

FIG. 1 is a diagram illustrating a wireless communication system 100. The wireless communication system 100 according to example embodiments of the present disclosure may be configured such that the user equipment which is not in the handover area of the base station may no longer frequently perform downlink reference signal strength measurement, thereby reducing the power consumption of the user equipment.

Referring to FIG. 1, the wireless communication system 100 may include at least one base station and/or at least one user equipment (UE). Although FIG. 1 shows that the wireless communication system 100 includes two base stations 101 to 102 and three UEs 201 to 203 (e.g., a UE 201, a UE 202 and a UE 203), this is only an example. The numbers of the base stations and the UEs included in the wireless communication system are not limited thereto.

The base station may communicate with UEs, and may be called other terms, for example, an access point (AP), a node B, etc. Each base station may provide communication coverage for a specific geographical area. The term “cell” may represent a coverage area of the base station.

Hereinafter, the “user equipment” and the “terminal” may be used interchangeably. Examples of user equipment may include, but not limited to, mobile phones, smart phones, tablet personal computers, personal digital assistant (PDA) devices, handheld devices with wireless communication functions, computing devices or other processing devices connected to wireless modems, wearable devices, vehicle-mounted devices, terminals in internet of vehicles, desktop computers, laptop computers, handheld computing devices, and/or other devices for communicating over wireless systems.

When the user equipment is within the cell of the base station, the user equipment may establish a connection with the base station to perform wireless communication service. In FIG. 1, UEs 201 to 203 may establish connections with base stations through connections 111, 112 and 212, respectively.

When the user equipment moves from the current cell to an adjacent cell, the base station performs mobility management on the user equipment. Referring to FIG. 1, after the user equipment 202 establishes a connection 112 with the current base station 101, the base station 101 transmits a measurement control request (for example, a downlink reference signal measurement request) to the user equipment 202. While the user equipment 202 moves towards the base station 102, the user equipment 202 continuously performs measurements for downlink reference signals. Specifically, the user equipment 202 continuously measures the downlink reference signal strength information of the base station 101 and the downlink reference signal strength information of the base station 102. When the downlink reference signal strength information (for example, reference signal received power (RSRP) and/or signal to interference plus noise ratio (SINR)) measured by the user equipment 202 meets a predetermined (or alternatively, given) condition, the user equipment 202 transmits the measured reference signal strength information to the base station 101. Based on the measured reference signal strength information, it may be determined that the user equipment 202 is already located at the edge of cell of the base station 101. The base station 101 performs mobility management on the user equipment 202, such that the user equipment establishes a connection 211 with the base station 102 and disconnects the connection 112 with the base station 101, thereby a cell handover is completed.

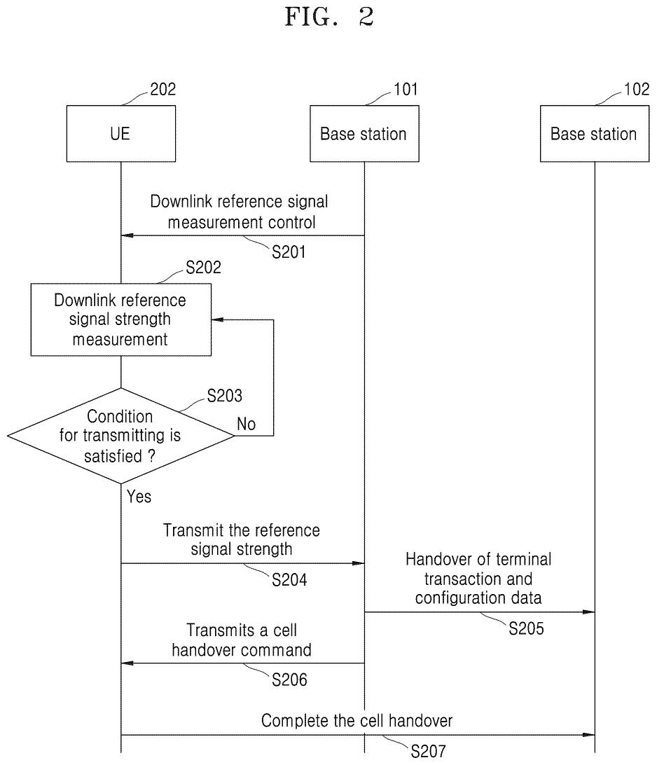

FIG. 2 illustrates a typical handover process based on downlink reference signal measurement.

Referring to FIG. 2, when the user equipment 202 establishes a connection with the base station 101, the base station 101 transmits a downlink reference signal measurement request to the user equipment 202 according to the handover protocol of 3GPP in operation S201. In operation S202, the user equipment 202 performs downlink reference signal strength measurement (e.g., in response to the downlink reference signal measurement request). The user equipment 202 may periodically measure downlink reference signal strengths of the current base station (e.g., the base station 101) and adjacent base stations.

In operation S203, the user equipment 202 determines whether a condition for transmitting reference signal strength information (for example, RSRP, SINR, etc.) to the base station is satisfied. When it is determined that the transmission condition is not satisfied (for example, the RSRP is greater than a predetermined (or alternatively, given) threshold), the user equipment 202 does not transmit the measured reference signal strength information to the base station, but continues to perform downlink reference signal strength measurement (e.g., if “No” in operation S203, return to operation S202). Satisfaction of the transmission condition indicates that the user equipment has reached the edge area of the cell of the base station 101, but has not left the cell of the base station. Based on a determination that the transmission condition is satisfied (“Yes” in operation S203), in operation S204, the user equipment 202 transmits the measured reference signal strength information to the base station 101. The user equipment 202 may periodically transmit the measured reference signal strength information to the base station 101 multiple times. In operation S205, the base station 101 performs a handover of terminal transaction and configuration data to the base station 102. In operation S206, the base station 101 transmits a cell handover command to the user equipment 202. In operation S207, the user equipment 202 is handed over to the cell of the base station 102.

Because the base station is unable to predict when the user equipment will reach the edge of the cell covered by the base station, the user equipment continuously performs the reference signal strength measurement after the base station transmits the downlink reference signal measurement request, until the handover is completed. Such frequent measurements of user equipment result in increased power consumption.

In addition, as the frequency of wireless communication increases and/or the movement speed of user equipment increases, the signal loss will increase, which results in decreased accuracy of user equipment's measurement for the current channel. For example, when the user equipment is located on a vehicle such as a high-speed moving train, if the base station makes a handover decision for the current time based on the measurement at a past time, a transaction interruption may occur due to the failure to complete the user equipment's handover to the adjacent cell in time.

The handover method and the mobile handover apparatus according to example embodiments of the present disclosure may fit the handover area of the cell in advance, based on the collected position information of the test UEs and the corresponding reference signal strength information, and perform mobility management on the user equipment based on the obtained handover area. Therefore, when the base station determines that the user equipment is not within the handover area, the user equipment does not need to (or otherwise, may not) frequently measure the downlink reference signal strength like the existing handover process, thereby the power consumption of the user equipment may be reduced.

In addition, the handover method and the mobile handover apparatus according to example embodiments of the present disclosure may generate moving trajectory data of the test user equipment, based on the position information of the test user equipment and the adjacent cell to which the test user equipment is handed over. Therefore, the base station may accurately predict the upcoming cell handover, based on a comparison between the moving trajectory data of the tested user equipment and the position information of the currently moving user equipment, and prepare for the handover of the user equipment in advance, thereby optimizing (or improving) mobility management, reducing the probability of transaction interruption due to the failure of user equipment's handover to the adjacent cell, and improving the user experience.

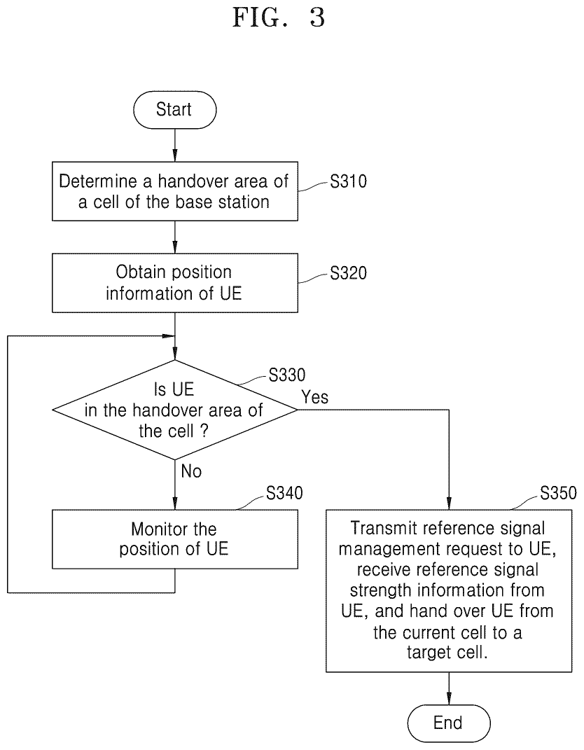

The handover method of the present disclosure will be described below with reference to FIGS. 3 to 6.

FIG. 3 is a flowchart illustrating a handover method performed by the base station according to example embodiments of the present disclosure.

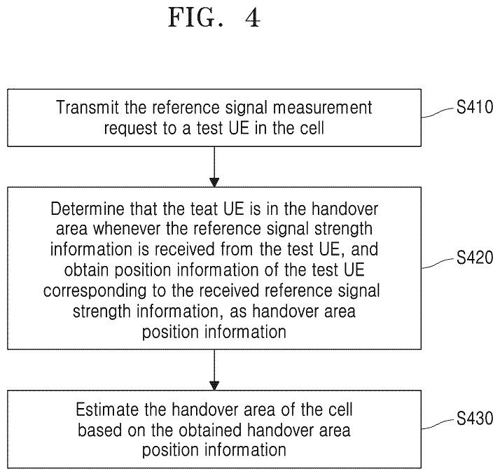

Referring to FIG. 3, in operation S310, the base station may determine a handover area of the cell of the base station. This will be described in detail with reference to FIG. 4.

FIG. 4 is block diagram illustrating a method of determining the handover area of the cell according to example embodiments of the present disclosure. During the mobility management on the user equipment according to the 3GPP handover protocol, the base station may collect the position information and reference signal strength information of the user equipment for the estimation of the handover area of the cell. The flow of mobility management on user equipment according to 3GPP handover protocol has been shown in FIG. 2, and it will not be described herein.

The user equipment, position information and reference signal strength information of which are collected for estimation of the handover area, is hereinafter referred to as a “test user equipment”. However, this is only for increased clarity, and the test user equipment may be any user equipment in the cell.

Referring to FIG. 4, in operation S410, the base station may transmit the reference signal measurement request to the test user equipment in the cell of the base station. In one example, the reference signal measurement request includes a downlink reference signal measurement request.

In response to the reference signal measurement request (or downlink reference signal measurement control) from the base station, the test user equipment in the cell may perform measurement of reference signal strength, and transmit the reference signal strength information to the base station when a predetermined (or alternatively, given) condition is satisfied (for example, the measured reference signal strength is less than a threshold). In other words, when the test user equipment starts to transmit the reference signal strength information to the base station, it indicates that the test user equipment has reached the edge of the cell.

In operation S420, whenever the base station receives the reference signal strength information from the test user equipment in response to the reference signal measurement request, the base station determines that the test user equipment is in the handover area, and obtains the position information of the test user equipment corresponding to the received reference signal strength information, as handover area position information related to the handover area of the cell. In other words, the base station defines an area in which the test user equipment transmits the reference signal strength information as the handover area. In one example, the reference signal strength information may include a reference signal received power RSRP. In other examples, the reference signal strength information may include, but is not limited to, the signal-to-noise ratio (SNR), the signal to interference plus noise ratio (SINR), etc.

In example embodiments, when the test user equipment transmits the reference signal strength information or other transaction signals to the base station, the base station may estimate an angle of arrival α based on a direction of uplink arrival of the test user equipment, and estimate a distance d between the test user equipment and the base station based on a delay of uplink arrival of the test user equipment, so as to obtain the position information of the test user equipment based on the angle of arrival α and the distance d. In example embodiments, the base station may estimate the angle of arrival α based on the Sounding Reference Signal (SRS) or the reference signal used for base station demodulation. In example embodiments, the base station may measure the phase and amplitude of the arrival using multi-antenna technology, and then calculate the angle of arrival (i.e., the angle of arrival α). This angle represents the direction of the test user equipment relative to the base station. Additionally, the base station obtains the time difference between the test user equipment and the base station (also known as Timing Advance) by calculating the time difference between receiving and transmitting signals by the test user equipment, as well as the time difference between receiving and transmitting signals by the base station. By multiplying this time difference by the speed of light and dividing by 2, the distance d between the test user equipment and the base station may be obtained. The base station then may estimate the location of the test user equipment using a triangulation algorithm, based on the angle of arrival α, the distance d, and other information (such as the location of the base station).

In example embodiments, the base station may obtain the position information of the test user equipment based on the Positioning reference signal (PRS). DL PRS is a new downlink reference signal introduced in 3GPP 5G NR R16, which is specifically for NR RAT-dependent positioning. It relies on the 5G network and can operate independently of satellite positioning. Positioning reference signals are typically transmitted by the base station and received by the user equipment. For example, multiple base stations may simultaneously transmit positioning reference signals to the test user equipment. By measuring the time differences between the arrivals of each positioning reference signals at the test user equipment, the distances from the test user equipment to each base station may be determined. Combined with the location information of each base station, the position of the test user equipment may be determined. However, this is just an example of using positioning reference signals to obtain the location of user equipment, and the present disclosure is not limited thereto.

Once the test user equipment is at the edge of the base station, the test user equipment may periodically transmit reference signal strength information to the base station, so the base station may obtain multiple positions of the test user equipment when receiving the reference signal strength information, and store the position information of the test user equipment and the corresponding reference signal strength information in pairs.

A fixed storage space may be allocated for each test user equipment, so as to record its position information and reference signal strength information.

For example, for the user equipment 202, when the position information of the test user equipment is determined based on the angle of arrival α and the distance d, the base station may store its position information in the form of “user equipment 202—{[α₁, d₁], [α₂, d₂], . . . }”. When the user equipment 202 is handed over from the cell of the current base station to an adjacent cell, the base station marks a position information recorded at the last moment of handover as [αₕₒ, dₕₒ], based on the handover of the user equipment 202. At this time, the recording process of the position information for the user equipment 202 ends.

Cyclic overwrite may be used in recording of multiple position information of test user equipment, so as to reduce the memory space. For example, when the data [αₘ, dₘ] has reached an end of the storage space, the new data [αₘ₊₁, dₘ₊₁] may overwrite the data [α₁, d₁] at a head of the memory space.

When the user equipment 202 is handed over from the base station 101 to the base station 102, the base station 101 may represent the moving trajectory data of the user equipment 202 as {[α₁, d₁], [α₂, d₂], . . . , [αₕₒ, dₕₒ]}. When the moving trajectory data of the test user equipment is recorded by means of cyclic overwrite, assuming that the memory space may store at most M sets of data for one test user equipment, the moving trajectory data of the test user equipment may be determined as the M sets of data backtracked from the last data [αₕₒ, dₕₒ].

The base station may further store reference signal strength information of a plurality of test UEs in a similar manner.

The position information and the reference signal strength information may be stored as data pairs. For example, for the user equipment 202, the base station may store its position information and reference signal strength information in the form of “user equipment 202—{[α₁, d₁, RSRP₁], [α₂, d₂, RSRP₂], . . . }”. When the user equipment 202 is handed over from the cell of the current base station to the adjacent cell, the base station records the information at the last moment of handover as [αₕₒ, dₕₒ, RSRPₕₒ] based on the handover information of the user equipment 202.

In operation S430, the handover area of the cell of the base station may be estimated based on the handover area position information.

Various classification, regression or clustering algorithms (including but not limited to support vector machine, random forest, gradient lifting, K-means, etc.) may be adopted to perform regression prediction or fitting on the handover area of the cell of the base station based on the position information about the handover area, so as to generate information on the handover area.

In example embodiments, the input data X input to a neural network model may be a multi-dimensional vector including the position information of the test user equipment. In an example, the input data X may be a vector represented by [αᵢ, dᵢ], where i is an index. In another example, the input data X may be a position coordinate [xᵢ, yᵢ] of the test user equipment indicated by the PRS signal. The output data (or label) Y may be corresponding reference signal strength information RSRPᵢ. In another example, the output data (or label) Y may be 1 or −1, where 1 means that the test user equipment is in the handover area, and −1 means that the user equipment is not in the handover area. According to example embodiments, the neural network model may be trained using training data including training input data (e.g., the multi-dimensional vector) matched with corresponding training output data (e.g., the corresponding reference signal strength information). As a result of the training, a functional relationship, such as Y=f(X), may be obtained to determine whether the test user equipment is in the handover area based on the positioning reference signal information of the test user equipment, or feature values, such as α/d/RSRP.

However, these are only examples, and the inventive concepts are not limited thereto.

In example embodiments, regression prediction or fitting about the handover area may be performed based on convolutional neural networks, support vector machines (SVM), support vector machine regression (SVR), and the like.

In example embodiments, a model representing a relationship between a position and the reference signal strength may be obtained based on the handover area position information and the corresponding reference signal strength information obtained; a set of candidate position information is predicted based on the model, wherein the reference signal strength information at a position indicated by the candidate position information is less than a threshold; and based on the set of candidate position information, the boundary of the handover area is fitted.

For example, a model representing a linear or nonlinear functional relationship between the reference signal strength information RSRPᵢ and the position information [αᵢ, dᵢ] or [xᵢ, yᵢ] of the test user equipment may be obtained. All candidate positions at which the predicted reference signal strength information RSRPᵢ is less than the threshold may be solved based on the model, and the handover area may be fitted based on the candidate positions. In another example, the reference signal strength information RSRP may be used to identify the handover area. For example, when the predicted RSRP is less than the threshold, it may be determined that the test user equipment is located in the handover area.

In example embodiments, because the base station defines the area, in which the test user equipment transmits the reference signal strength information to the base station, as the handover area, the boundary of the handover area may be obtained using various fitting algorithms based on the position information of the test user equipment located in the handover area (e.g., the test user equipment whose RSRPᵢ is less than the threshold), that is, handover area position information. The boundary of the handover area may be indicated by the position information.

The test user equipment in the handover area will periodically transmit reference signal strength information to the base station, so that the base station may obtain multiple pieces of position information of the test user equipment in the handover area. For example, when the test user moves to the edge of the cell and the reference signal strength satisfies a predetermined condition configured by the base station (for example, less than a predetermined threshold), the test user equipment may feedback the downlink reference signal strength information to the base station, so that the base station knows that the test user has arrived the handover area. Thus, the base station starts to configure the downlink PRS for the test user equipment to obtain the position information of the test user equipment. Alternatively, the base station may obtain the angle of arrival α, distance d, and reference signal received power (RSRP) of the test user equipment using the base station's multi-antenna measurement technology. As mentioned previously, the base station may obtain the position information of the test user equipment based on such information. When the test user equipment is handed over from the current cell to the adjacent cell, a plurality of pieces of position information thereof may be expressed as a position scatter diagram with coordinates (for example, [xᵢ, yᵢ] or [αᵢ, dᵢ]). Various fitting algorithms (e.g., least square method) or machine learning algorithms may be used to estimate the boundary of the position scatter diagram, as the boundary of the handover area of the cell.

In one example, the handover area of the base station may be estimated as an irregular annular area centered at the base station. At this time, the boundary of the handover area may include an inner boundary and an outer boundary. The inner boundary of the handover area may be fitted using the handover area position information (or position coordinates) which indicates a position closest to the base station among the obtained handover area position information, and the outer boundary of the handover area may be fitted using the handover area position information which indicates a last position coordinates (for example, [αₕₒ, dₕₒ]) of the test user equipment before handover to the target cell among the obtained handover area position information. Based on the inner and outer boundaries of the handover area, the handover area map of the base station may be generated.

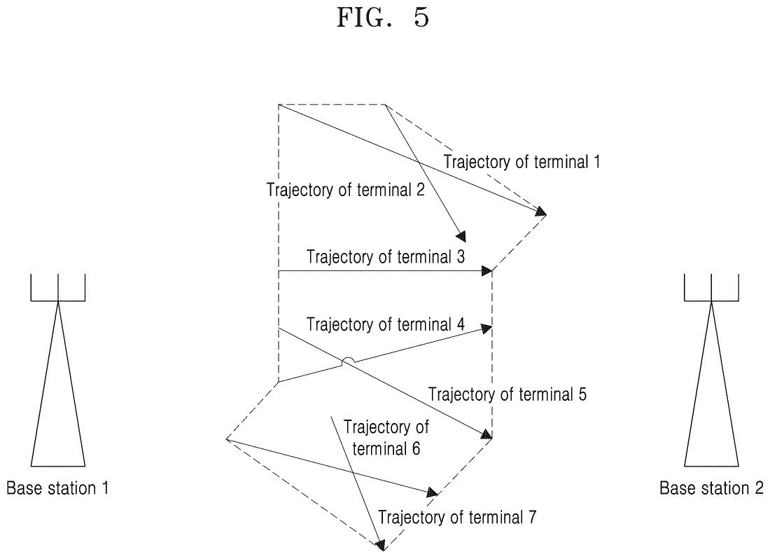

FIG. 5 is a diagram illustrating determining a handover area of the cell according to example embodiments of the present disclosure.

Referring to FIG. 5, assuming that the base station 1 has recorded the position information and corresponding reference signal strength information of seven test UEs (or terminals), which are handed over from the base station 1 to the base station 2, in the cell, and thus the base station may estimate the handover area of the cell based on these position information and the corresponding reference signal strength information. In addition, the base station may generate the moving trajectory data of each test user equipment based on the position information. Although FIG. 5 shows seven test UEs, this is only an example, and the number of test UEs in a cell is not limited thereto.

The handover area of the cell may be located between the cell of the base station 1 (or referred to as the source cell) and the cell of the adjacent base station 2 (or referred to as the target cell). The handover area may include an overlapping area between the source cell and the target cell (e.g., that overlaps both of the source cell and the target cell). The user equipment in the cell of the base station 1 transmits reference signal strength information to the base station 1 when entering the handover area, and is handed over from the cell of the base station 1 to the cell of the base station 2 when leaving the handover area and moving towards the cell of the base station 2.

The handover area of the cell may include the boundary of the handover area. The boundary of the handover area may be indicated by position information. By obtaining a large amount of position information of the test UEs which are handed over from the current cell to the adjacent cell (for example, a position closest to the base station and a position at which handed over to the target cell), the boundary of the handover area of the cell may be estimated, so as to obtain the range of the handover area of the cell.

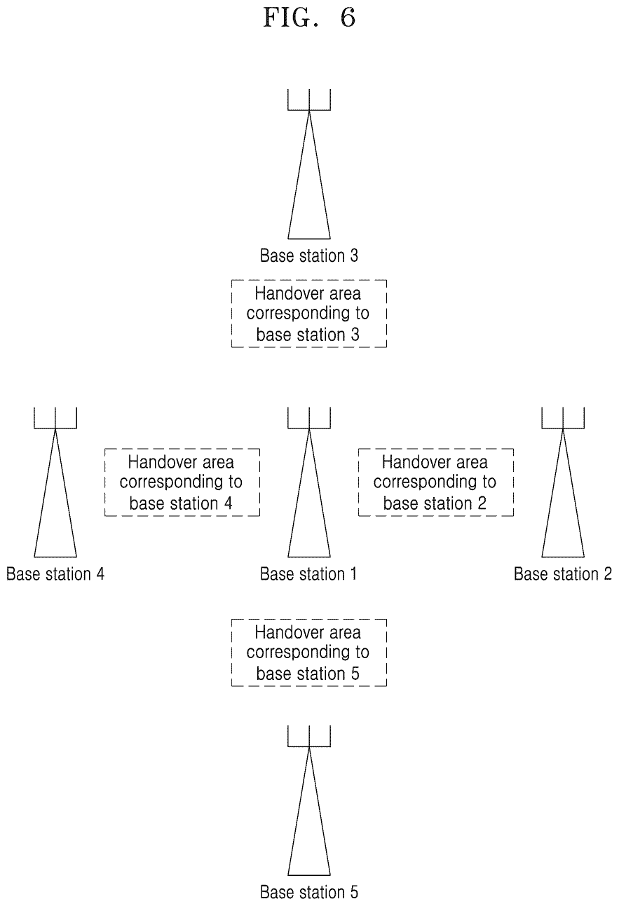

FIG. 6 is diagram illustrating determining the handover area of the cell according to example embodiments of the present disclosure.

With respect to a plurality of adjacent base stations, a handover area (e.g. a handover sub-area), among the handover area of cell of the current base station, corresponding to each of the plurality of adjacent base stations may be generated. Referring to FIG. 6, when there are four adjacent base stations around the base station 1 (that is, base station 2 to base station 5), the handover area (e.g., handover sub-area), among the handover area of cell of the base station 1, corresponding to each adjacent base station may be respectively generated based on the method described with reference to FIG. 4.

Position information of the plurality of adjacent base stations (or adjacent cells) may be obtained, and the handover area (e.g., handover sub-area) corresponding to each adjacent cell among the handover area of the cell of the base station may be obtained based on the collected position information of the test user equipment (e.g., the handover area position information) and the position information of the adjacent base stations.

In example embodiments, the base station 1 may obtain the position coordinates of all the base stations adjacent to it through the interface between base stations (for example, X2 interface), thereby generating a base station map. Then, the base station 1 may respectively obtain the position information of the test UEs which are handed over from the base station 1 to each of the respective base stations (that is, base station 2 to base station 5), to generate moving trajectory data, thereby estimating the handover areas (e.g., handover sub-areas) corresponding to each of the respective base stations, among the handover area of cell of the base station 1.

FIG. 6 exemplarily shows the handover area (e.g., handover sub-areas) corresponding to each of the base stations 2 to 5, among the handover area of cell of the base station 1. Although in FIG. 6, each handover area (e.g., handover sub-area) is shown as a rectangle, it is only an example, and the shape of the handover area (e.g., handover sub-area) is not limited thereto.

In example embodiments, there may be overlapping areas between the respective handover areas (e.g., handover sub-areas). For example, when the test user equipment is located in an overlapping area between a handover area (e.g., handover sub-area) corresponding to base station 3 and a handover area (e.g., handover sub-area) corresponding to base station 4, the test user equipment may be handed over to base stations 3 or 4 later.

When the test user equipment is located in the above overlapping area, since the reference signal strength information transmitted by the test user equipment to the base station 1 includes not only the reference signal strength information for the base station 1, but also the reference signal strength information for the base stations 3 and 4, the base station 1 may select the target base station or target cell to which the test user equipment will be handed over, based on the reference signal strength information for the base stations 3 and 4. For example, the base station 1 may select the base station with a greater RSRP among the base stations 3 and 4 as the target base station to which the user equipment will be handed over. However, this is only an example, and the inventive concepts are not limited thereto.

The base station 1 may dynamically maintain the handover areas of the base station 1.

When it is determined that the position and/or number of target cells adjacent to the cell of the base station have changed (e.g., based on information received from the target cells through the interface between base stations (for example, X2 interface)), the base station may re-perform operations S410 to S430 of determining the handover area of the cell.

When a specific user equipment is handed over from the base station 1 to the base station 2 without being located in the handover area between the base station 1 and the base station 2, the base station re-determines the handover area based on the position information of the specific user equipment. When the position information of the test user equipment exists for more than a predetermined (or alternatively, given) time, the moving trajectory data of the test user equipment may be deleted from the memory space of the base station 1.

After the handover area of the cell is estimated, the base station may store the handover area model of the cell or information about the handover area of the cell in the memory.

Referring back to FIG. 3, after the base station has determined the handover area of the cell, in operation S320, the base station may obtain the position information of the user equipment in the cell of the base station. As described above, the base station may obtain the position information of the user equipment based on the angle of arrival α and the distance d when performing normal transaction with the user equipment, or obtain the position information of the user equipment based on the positioning reference signal PRS.

In operation S330, the base station may determine whether the user equipment is in the handover area of the cell of the base station, based on the position information of the user equipment.

In example embodiments, based on a handover area model representing the relationship between position information in the handover area and corresponding reference signal strength information, the base station may obtain predicted reference signal strength information based on the position information of the user equipment, and compare it with a threshold. When the predicted reference signal strength information is less than the threshold, the base station may determine that the user equipment is in the handover area.

In example embodiments, based on the estimated boundary information of the handover area or the handover area map, the base station may determine whether the user equipment is within the handover area based on the position information of the user equipment.

When it is determined that the user equipment is in the handover area of the cell (e.g., “Yes” in operation S330), in operation S350, the base station performs handover and mobility management on the user equipment according to the 3GPP handover protocol. For example, referring to FIG. 2, the base station may transmit the reference signal measurement request to the user equipment, receive reference signal strength information corresponding to the reference signal measurement request from the user equipment, and hand over the user equipment from the cell of the base station to the adjacent target cell. According to example embodiments, the base station may hand over the user equipment by generating a handover request message (e.g., containing terminal transaction and configuration data), transmitting the handover request message to the adjacent target cell, receiving an acknowledgement message (e.g., containing configuration data for use by the user equipment connecting to the adjacent target cell) in response to the handover request message, generating a handover command message (e.g., containing the configuration data for use by the user equipment connecting to the adjacent target cell), and transmitting the handover command message to the user equipment. According to example embodiments, the user equipment may receive the handover command message, establish a connection with the adjacent target cell (e.g., using the received configuration data), generate a first signal, process the first signal to perform one or more among modulating, upconverting, filtering, amplifying and/or encrypting on the first signal, and transmit the processed first signal to an external device (e.g., to the station to report completion of hand over). Additionally or alternatively, the user equipment may receive a second signal from the external device, process the second signal to perform one or more among demodulating, downconverting, filtering, amplifying and/or decrypting on the second signal, and perform a further operation(s) based on the processed second signal. For example, the further operation(s) may include one or more of providing the processed second signal to a corresponding application executing on the user equipment, storing the processed second signal, sending a response signal to the external device (e.g., based on a processing result of the corresponding application executing on the user equipment), etc.

The base station may also generate moving trajectory data of the test user equipment located in the handover area, based on the plurality of pieces of position information of the test user equipment obtained when estimating the handover area. When determining that the current user equipment is located in the handover area, the base station may predict a cell to which the user equipment will be handed over in advance based on the comparison between the position information of the user equipment and the moving trajectory data of the test user equipment, and configure the corresponding handover information.

In example embodiments, when there are roads, railways, rivers or the like near the base station, while estimating the handover area, the base station will collect similar moving trajectories from a large number of test UEs, and such test UEs are likely to handed over from the current base station to a same target base station (or a similar target base station). Therefore, the base station may establish a moving trajectory database based on this information, which includes the moving trajectory of the test UEs and the information of the target cell to be finally handed over.

When it is determined that the user equipment is already in the handover area, the base station may obtain multiple pieces of position information of the user equipment when receiving the reference signal strength information transmitted by the user equipment, so as to generate the current moving trajectory of the user equipment. The base station may compare the current moving trajectory of the user equipment with the moving trajectory database of the test user equipment. When a similarity between the current moving trajectory of the user equipment and the moving trajectory of the specific test user equipment in the database exceeds a threshold (for example, 80%), the base station may predict the target cell to which the user equipment will be handed over, based on the target cell to which the test user equipment is handed over, and perform a handover of the terminal transaction data and configuration data with the target cell in advance, so as to reduce the probability that the base station may not complete the cell handover due to the higher moving speed of the user equipment.

When it is determined that the user equipment is not in the handover area of the cell (e.g., “No” in operation S330), in operation S340, the base station monitors the position of the user equipment without transmitting the reference signal measurement request to the user equipment.

For example, for a user equipment initially residing in the cell of the base station 1, the base station 1 first determines whether the user equipment is in any handover area of the base station 1. If the user equipment is not in any handover area, the base station 1 does not transmit (or delays transmitting) the downlink reference signal measurement request to the user equipment, so the user equipment does not need to (or does not) frequently measure the reference signal reception power of the current cell and adjacent cells. In other words, for the user equipment that is not in the handover area, operations S201 to S203 shown in FIG. 2 are not performed (or are delayed).

Although the base station 1 does not perform the downlink reference signal measurement control on the user equipment, the base station 1 always (or periodically) detects the position of the user equipment. In example embodiments, the base station may obtain the position information of the user equipment through the angle of arrival α and the distance d while the user equipment performing communication transaction (or periodic communications), or obtain the position information of the user equipment based on the positioning reference signal PRS. In this case, the user equipment does not need to (or may not) additionally measure and transmit position information and reference signal strength information, but the base station 1 may keep monitoring the position of the user equipment, to determine whether the user equipment enters the handover area.

When the user equipment moves to a certain handover area of the base station 1 (for example, moves to a handover area between the base station 1 and the base station 2), the base station 1 performs handover and mobility management on the user equipment according to the 3GPP handover protocol, and hands over the user equipment from the cell of the base station 1 to the cell of the base station 2. When the user equipment leaves the handover area and enters the cell of the base station 2, the base station 1 stops the reference signal measurement control for the user equipment.

In example embodiments, when the user equipment is not in any handover area of the base station 1 but transmits a radio resource control re-establishment (RRC Re-establishment, also referred to as RRE) signal to the terminal, the base station 1 performs handover and mobility management on the user equipment according to the 3GPP handover protocol. If the user equipment is handed over to a known adjacent cell later, the base station 1 updates the handover area of the cell based on the moving trajectory of the user equipment. If the user equipment is handed over to an unknown adjacent cell later, the base station 1 adds a handover area between the cell and the unknown adjacent cell, based on the moving trajectory information of the user equipment. If the user equipment resides in the cell of the base station 1 all the time (e.g., longer than a threshold time duration), this may signify that the user equipment has a fault. The base station 1 may perform handover and mobility management on the user equipment according to the 3GPP handover protocol without performing the handover method disclosed in the present application for the user equipment.

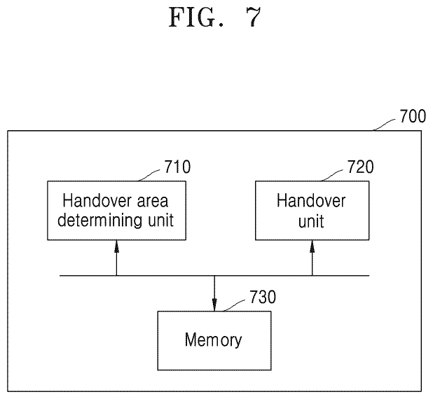

FIG. 7 is a block diagram illustrating a mobile handover apparatus 700 according to example embodiments of the present disclosure.

As shown in FIG. 7, the mobile handover apparatus 700 according to example embodiments of the present disclosure may be a base station, an access point, a node B, or a part thereof.

The mobile handover apparatus 700 may include a handover area determining unit 710, a handover unit 720, and/or a memory 730.

The handover area determining unit 710 may estimate the handover area of the cell, by obtaining a large amount of position information and reference signal strength information of the test user equipment handed over from the current cell to the adjacent cell.

The handover area determining unit 710 may transmit the reference signal measurement request to the test user equipment in the cell. Whenever reference signal strength information corresponding to the reference signal measurement request is received from the test user equipment, the handover area determining unit 710 may determine that the test user equipment is in the handover area, and obtain the position information of the test user equipment corresponding to the received reference signal strength information, as handover area position information related to the handover area of the cell. The handover area determining unit 710 may estimate the handover area of the cell based on the handover area position information.

The handover unit 720 may perform mobility management on the user equipment in the cell. The handover unit 720 may obtain the position information of the user equipment; determining whether the user equipment is in the handover area of the current cell based on the position information of the user equipment; and when it is determined that the user equipment is in the handover area of the current cell, the handover unit 720 transmits a reference signal measurement request to the user equipment, receives the reference signal strength information corresponding to the reference signal measurement request from the user equipment, and hands over the user equipment from the current cell to the target cell adjacent to the current cell. When it is determined that the user equipment is not in the handover area of the current cell, the handover unit 720 monitors the position of the user equipment without transmitting (or while delaying transmission of) the reference signal measurement request to the user equipment.

The memory 730 may store position information of the user equipment, reference signal strength information, and information about the handover area of the cell.

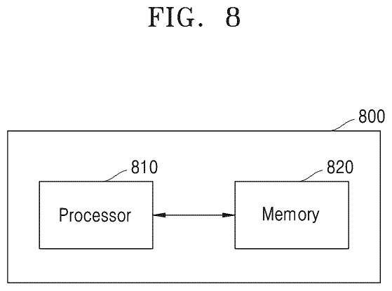

FIG. 8 is a block diagram illustrating a user equipment 800 according to example embodiments of the present disclosure.

As shown in FIG. 8, the user equipment 800 according to example embodiments of the present disclosure may include a processor 810 and/or a memory 820.

The processor 810 may control overall operation of the user equipment and may control a part or all of internal components of the user equipment. The processor 810 may be implemented as a wireless communication baseband processor, a communication processor CP, a general processor, an application processor (AP), an application specific integrated circuit, a field programmable gate array, etc., but example embodiments are not limited thereto. The processor 810 may be configured to achieve energy saving according to the handover method disclosed herein.

The memory 820 may include volatile memory and/or nonvolatile memory. The memory 820 may store various data generated and used by the user equipment. For example, the memory 820 may store an operating system and/or application programs (e.g., application programs associated with the method of the inventive concepts) for controlling the operation of the user equipment.

The handover method and the mobile handover apparatus according to example embodiments of the present disclosure may determine or estimate the handover area of the cell in advance, based on the collected trajectory data of the user equipment, and perform mobility management on the user equipment based on the handover area. Therefore, when the user equipment is not in the handover area, it is unnecessary to perform the signal strength measurement frequently according to the existing 3GPP handover protocol, thereby reducing the power consumption of the user equipment. In addition, after estimating the handover area of the cell, the base station may accurately predict the upcoming cell handover event, and configure the user equipment to handover to the target cell through HO (hand over), or configure the user equipment to enter the dual connective or coordinated multipoint transmission/reception (CoMP) state in advance. Therefore, even if the user equipment moves at a higher speed, the base station may reduce the probability of transaction interruption due to the failure of the user equipment's handover to the target cell, and improve the user experience.

The apparatuses, units, modules, devices, and other components described herein are implemented by hardware components. Examples of hardware components that may be used to perform the operations described in this application where appropriate include controllers, sensors, generators, drivers, memories, comparators, arithmetic logic units, adders, subtractors, multipliers, dividers, integrators, and/or any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, and/or any other device or combination of devices that is configured to respond to and execute instructions in a defined manner to achieve a desired result. In an example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods that perform the operations described in this application are performed by computing hardware, for example, by one or more processors or computers, implemented as described above executing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control a processor or computer to implement the hardware components and perform the methods as described above are written as computer programs, code segments, instructions or any combination thereof, for individually or collectively instructing or configuring the processor or computer to operate as a machine or special-purpose computer to perform the operations performed by the hardware components and the methods as described above. In an example, the instructions and/or software include machine code that is directly executed by the processor or computer, such as machine code produced by a compiler. In another example, the instructions or software include higher-level code that is executed by the processor or computer using an interpreter. Persons and/or programmers of normal skill in the art may readily write the instructions and/or software based on the block diagrams and the flow charts illustrated in the drawings and the corresponding descriptions in the specification, which disclose algorithms for performing the operations performed by the hardware components and the methods as described above.

The instructions or software to control a processor or computer to implement the hardware components and perform the methods as described above, and any associated data, data files, and data structures, are recorded, stored, or fixed in or on one or more non-transitory computer-readable storage media. Examples of a non-transitory computer-readable storage medium include at least one of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and providing the instructions or software and any associated data, data files, and data structures to a processor or computer so that the processor or computer may execute the instructions.

Conventional devices and methods for managing the mobility of a UE involve the UE performing continuous (or repeated periodic) reference signal strength measurements to determine whether a handover to a cell of a different base station is appropriate. These continued (or repeated) measurements result in excessive resource consumption (e.g., power, processor, memory, bandwidth, etc.).

However, according to example embodiments, improved devices and methods are provided for managing the mobility of a UE connected to a base station. For example, the improved devices and methods may involve comparing position information of the UE to a handover area of a cell of the base station. The base station may only transmit a request to the UE to perform reference signal strength measurement in response to determining the UE is located within the handover area. Otherwise, the base station may cause the UE to refrain from performing the reference signal strength measurements by withholding (or delaying transmission of) the request. Accordingly, the improved devices and methods may overcome the deficiencies of the conventional devices and methods to at least reduce the amount of reference signal strength measurements performed by the UE, thereby reducing resource consumption (e.g., power, processor, memory, bandwidth, etc.).

According to example embodiments, operations described herein as being performed by each of the base stations 1 to 5, each of the terminals 1 to 7, the wireless communication system 100, each of the base stations 101 and 102, each of the UEs 201 to 203, the mobile handover apparatus 700, the handover area determining unit 710, the handover unit 720, the user equipment 800, and/or the processor 810 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a graphics processing unit (GPU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm, and/or functions, described in connection with example embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 730 and/or the memory 820). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

In example embodiments, the processing circuitry may perform some operations (e.g., the operations described herein as being performed by the neural network model) by artificial intelligence and/or machine learning. As an example, the processing circuitry may implement an artificial neural network (e.g., the neural network model) that is trained on a set of training data by, for example, a supervised, unsupervised, and/or reinforcement learning model, and wherein the processing circuitry may process a feature vector to provide output based upon the training. Such artificial neural networks may utilize a variety of artificial neural network organizational and processing models, such as convolutional neural networks (CNN), recurrent neural networks (RNN) optionally including long short-term memory (LSTM) units and/or gated recurrent units (GRU), stacking-based deep neural networks (S-DNN), state-space dynamic neural networks (S-SDNN), deconvolution networks, deep belief networks (DBN), and/or restricted Boltzmann machines (RBM). Alternatively or additionally, the processing circuitry may include other forms of artificial intelligence and/or machine learning, such as, for example, linear and/or logistic regression, statistical clustering, Bayesian classification, decision trees, dimensionality reduction such as principal component analysis, and expert systems; and/or combinations thereof, including ensembles such as random forests.

Herein, the machine learning model (e.g., the neural network model) may have any structure that is trainable, e.g., with training data. For example, the machine learning model may include an artificial neural network, a decision tree, a support vector machine, a Bayesian network, a genetic algorithm, and/or the like. The machine learning model will now be described by mainly referring to an artificial neural network, but example embodiments are not limited thereto. Non-limiting examples of the artificial neural network may include a convolution neural network (CNN), a region based convolution neural network (R-CNN), a region proposal network (RPN), a recurrent neural network (RNN), a stacking-based deep neural network (S-DNN), a state-space dynamic neural network (S-SDNN), a deconvolution network, a deep belief network (DBN), a restricted Boltzmann machine (RBM), a fully convolutional network, a long short-term memory (LSTM) network, a classification network, and/or the like.

While example embodiments have been described, it will be apparent to one of normal skill in the art that various changes in form and details may be made in these examples without departing from the spirit and scope of the claims and their equivalents.

What is claimed is:

1. A handover method performed by a base station, the handover method comprising:
obtaining first position information of a user equipment;
determining whether the user equipment is in a handover area of a first cell of the base station based on the first position information;
transmitting a reference signal measurement request to the user equipment in response to determining the user equipment is in the handover area;
receiving reference signal strength information from the user equipment, the reference signal strength information corresponding to the reference signal measurement request; and
handing over the user equipment from the first cell to a target cell adjacent to the first cell.

2. The handover method of claim 1, wherein
the user equipment is a first user equipment, and the reference signal measurement request is a first reference signal measurement request; and
the handover method further comprises monitoring a position of a second user equipment without transmitting a second reference signal measurement request to the second user equipment in response to determining the second user equipment is not in the handover area.

3. The handover method of claim 1, wherein
the reference signal measurement request includes a downlink reference signal measurement request; and
the reference signal strength information includes a reference signal reception power (RSRP).

4. The handover method of claim 2, wherein the monitoring of the position of the second user equipment comprises:
estimating an angle of arrival based on a direction of uplink arrival of the second user equipment;
estimating a distance between the second user equipment and the base station based on a delay of uplink arrival of the second user equipment; and
obtaining second position information of the second user equipment based on the angle of arrival and the distance.

5. The handover method of claim 2, wherein the monitoring of the position of the second user equipment comprises:
obtaining second position information of the second user equipment based on a positioning reference signal.

6. The handover method of claim 1, further comprising:
determining the handover area, the handover area including an overlapping area that overlaps both of the first cell and the target cell.

7. The handover method of claim 6, wherein
the reference signal measurement request is a first reference signal measurement request, and the reference signal strength information is first reference signal strength information; and
the determining of the handover area comprises:
transmitting a second reference signal measurement request to a test user equipment in the cell,
determining that the test user equipment is in the handover area based on receiving second reference signal strength information from the test user equipment, the second reference signal strength information corresponding to the second reference signal measurement request,
obtaining position information of the test user equipment as handover area position information, and
estimating the handover area based on the handover area position information.

8. The handover method of claim 7, wherein the estimating of the handover area comprises:
fitting a boundary of the handover area based on the handover area position information.

9. The handover method of claim 8, wherein
the handover area position information indicates a plurality of positions;
the boundary of the handover area includes an inner boundary and an outer boundary; and
the estimating of the handover area comprises:
fitting the inner boundary using the handover area position information indicating a position closest to the base station among the plurality of positions, and
fitting the outer boundary of the handover area using the handover area position information which indicates a last position of the test user equipment before handover to an adjacent cell among the plurality of positions.

10. The handover method of claim 8, wherein the estimating of the handover area comprises:
obtaining a model representing a relationship between a first position and a reference signal strength, the first position being indicated in the handover area position information, and the reference signal strength being based on the second reference signal strength information;
predicting a set of candidate position information based on the model, third reference signal strength information at a second position indicated by the candidate position information being less than a threshold; and
fitting the boundary of the handover area based on the set of candidate position information.

11. The handover method of claim 7, wherein
the target cell is a first target cell; and
the handover method further comprises updating the handover area including repeating the determining of the handover area in response to determining that positions of target cells and/or numbers of the target cells have changed, the target cells including the first target cell, and the target cells being adjacent to the first cell.

12. The handover method of claim 11, wherein the estimating of the handover area comprises:
obtaining position information of the target cells; and
estimating a respective handover sub-area among the handover area corresponding to each among the target cells based on the handover area position information and the position information of the target cells.

13. The handover method of claim 12, wherein
the target cells includes a first target cell and a second target cell, the first reference signal strength information including third reference signal strength information corresponding to the first target cell and fourth reference signal strength information corresponding to the second target cell;
an overlapping area exists between a first handover sub-area corresponding to the first target cell and a second handover sub-area corresponding to the second target cell, both of the first handover sub-area and the second handover sub-area being included within the handover area; and
the handover method further comprises selecting the first target cell based on the third reference signal strength information and the fourth reference signal strength information about the second target cell in response to determining the user equipment is located in the overlapping area.

14. The handover method of claim 7, wherein
the target cell is a first target cell;
the handover method further comprises generating moving trajectory data of the test user equipment based on the handover area position information; and
the handing over of the user equipment comprises selecting the first target cell based on a comparison between the moving trajectory data and the first position information of the user equipment.

15. A mobile handover apparatus in a wireless communication network comprises:
a memory configured to store information about a handover area of a current cell; and
processing circuitry configured to,
obtain position information of a user equipment,
determine whether the user equipment is in the handover area based on the position information,
transmit a reference signal measurement request to the user equipment in response to determining the user equipment is in the handover area,
receive reference signal strength information from the user equipment, the reference signal strength information corresponding to the reference signal measurement request, and
hand over the user equipment from the current cell to a target cell adjacent to the current cell.

16. The mobile handover apparatus of claim 15, wherein the processing circuitry is further configured to:
monitor a position of the user equipment without transmitting the reference signal measurement request to the user equipment in response to determining the user equipment is not in the handover area.

17. The mobile handover apparatus of claim 16, wherein the processing circuitry is configured to determine the handover area, the handover area including an overlapping area that overlaps the current cell and the target cell.

18. The mobile handover apparatus of claim 17, wherein
the reference signal measurement request is a first reference signal measurement request, and the reference signal strength information is first reference signal strength information; and
the processing circuitry is configured to:
transmit a second reference signal measurement request to a test user equipment in the current cell,
determine that the test user equipment is in the handover area based on receiving second reference signal strength information from the test user equipment, the second reference signal strength information corresponding to the second reference signal measurement request,
obtain position information of the test user equipment as handover area position information, and
estimate the handover area based on the handover area position information.

19. A wireless communication system comprising:
a user equipment; and
a base station configured to,
obtain position information of a user equipment,
determine whether the user equipment is in a handover area of a first cell of the base station based on the position information,
transmit a reference signal measurement request to the user equipment in response to determining the user equipment is in the handover area,
receive reference signal strength information from the user equipment, the reference signal strength information corresponding to the reference signal measurement request, and
hand over the user equipment from the first cell to a target cell adjacent to the first cell,
wherein the user equipment is configured to,
periodically perform a downlink reference signal strength measurement in response to receiving the reference signal measurement request from the base station to obtain a measured downlink reference signal strength, and
transmit the reference signal strength information to the base station based on the measured downlink reference signal strength meeting a condition.

20. A non-transitory computer-readable storage medium storing instructions that, when executed by processing circuitry, cause the processing circuitry to perform the handover method of claim 1.
